(19) United States
(12) Patent Application Publication
(10) Pub. No.: US 2009/0276335 A1
(43) Pub. Date: Nov. 5, 2009

(54) System and Method for Selling Cable Products

(76) Inventor: Noel Lee, Las Vegas, NV (US)

Correspondence Address: LARIVIERE, GRUBMAN & PAYNE, LLP, 19 UPPER RAGSDALE DRIVE, SUITE 200, MONTEREY, CA, 93940, US

(21) Appl. No.: 12/330,425

(22) Filed: Dec. 8, 2008

Related U.S. Application Data
(60) Provisional application No. 61/012,412, filed on Dec. 7, 2007.

(51) Int. Cl. G06Q 30/00; G06Q 50/00; G06Q 90/00

(52) U.S. Cl. 705/27; 705/500

(57) ABSTRACT

System and method for selling cable products. Indicia are assigned to various types of cable, indicating attributes including relative data transmission capacity of each cable type. A three-dimensional graphical depiction of a series of concentric pipes illustrates data bandwidth requirements of various technologies.

### CROSS-REFERENCE TO RELATED DOCUMENTS

This non-provisional application is based on and claims priority to U.S. Provisional Application Ser. No. 61/012,412 filed on Dec. 7, 2007.

### TECHNICAL FIELD

The present invention relates to the field of selling cable products. More particularly, the present invention relates to a system and method for selling cable products with varying attributes.

### BACKGROUND ART

Improvements in the area of home theater technology have led to the development of methods and devices employing increasingly faster rates of data transmission. Consequently, data cables that interconnect such devices must be of sufficient data transmission bandwidth to facilitate proper function and optimal performance of a home theater system. However, consumers are often confused about cable parameters and or the need for such varying functionality, as many cables are externally similar in appearance, though vastly different in performance and attributes.

Considering television video technology in further detail, the amount of data required to produce a video display depends on a multitude of factors, including, among other things, video resolution, frame rate, and color depth. At present, there are primarily four resolutions employed in consumer televisions: 480p, 720p, 1080i, and 1080p. These have corresponding pixel-counts (per field) of 345,600 pixels, 921,600 pixels, 1,036,800 pixels, and 2,073,600 pixels, respectively. Frame rates reflect the number of times per second a display is refreshed, and generally range from approximately 50 Hz to 120 Hz. The color depth indicates the number of colors available for display, reflected in the number of bits used to represent colors. Thus, a typical 8-bit per plane color depth can support 16777216 colors, whereas a 12-bit per plane color depth can support up to 68719476736 colors.

The overall data fate necessary for a given video display is a product of the display's resolution, frame rate, and color depth. Thus, a display having 480p resolution at 8-bit color depth and 50 Hz frame rate requires a data bandwidth of roughly 0.81 Gbps (Gigabits per second). Whereas a display having 1080p resolution at 12-bit color depth and 100 Hz frame rate requires approximately 14.93 Gbps.

High-definition multimedia interface (“HDMI”) is a standardized interface for digital audio and video data transmission. Since HDMI's inception there have been four versions of HDMI, with successive versions supporting expanded functionality and higher data bandwidths. However, the physical appearance of the HDMI connector has not changed, meaning that HDMI cables can look largely similar from one to the next, though their actual data bandwidth capacities may differ quite markedly. This creates potential confusion for the consumer seeking to purchase an HDMI cable, who cannot rely on the appearance of a cable to accurately indicate the range of applications for which it may be suitable. Moreover, the consumer who already owns an HDMI cable may decide to upgrade her home theater equipment without realizing that her existing HDMI cable is no longer adequate for the increased bandwidth requirements of the new equipment.

When cables are produced at increased lengths, their ability to transmit digital audio/video without loss of data decreases. Thus, a given cable type may be suitable for a 1080p display; but if it is manufactured at an increased length, it may no longer be suitable for such display. Consumers and salespersons are often unaware of the effect of length on a cable's bandwidth, and may mistakenly think that a longer version of a cable will be suitable for the same purpose.

Additionally, as HDMI standards continue to change and consumer audio and video products evolve and advance, it is likely that even higher data rates will be required, and resulting higher bandwidth cables will be offered in the marketplace. This will likely cause more confusion amongst consumers for the aforementioned and following reasons.

Therefore, what is needed is a system and method for selling cables in which the various data rate capacities of different types of cable are communicated in a clear and concise manner to the consumer so that they can easily purchase appropriate cables that will enable their home theater equipment to operate at optimal levels.

### SUMMARY OF THE INVENTION

An improved system and method for selling cable products is herein disclosed. Indicia indicating relative data bandwidth capability are assigned to different cable types, thereby providing a simplified system for comparison of cable performance. The indicia may be correlated to data bandwidth requirements or capacity of various home theater technologies, among other characteristics. Further, a three-dimensional graphical representation of a series of concentric pipes having relative diameters that correlate to the relative bandwidth requirements of various home theater technologies may provide a striking visual presentation representative of various data requirements and the consequent need for appropriate cables.

### BRIEF DESCRIPTION OF THE DRAWINGS

FIG. 1 illustrates a series of speed-rating badges indicative of data cable bandwidth in accordance with an embodiment of the present invention.

FIG. 2 illustrates a series of speed-rating badges with an underlying scale to more clearly show relative data bandwidth.

FIG. 3 is a two-dimensional graphical representation of the data bandwidth requirements of various video displays.

FIG. 4 is a three-dimensional graphical representation of the data bandwidth requirements of various video displays in accordance with an embodiment of the present invention.

### BEST MODES FOR CARRYING OUT THE INVENTION

The present invention is drawn to a system and method for selling data transmitting cable products that addresses the problem of confusion produced by the variety of cable products in the marketplace, in essence representing the technical and physical qualities of a cable in an easy to understand form. In accordance with the present invention, speed-rating emblems or other graphical representations or indicia are assigned to various cable types to indicate their attributes, such as the relative bandwidth capability, the capacity, or other attributes, of each cable type, thus accounting for and representative of the numerous factors that affect a cable's attributes and bandwidth in an easily understood indicia form.

The emblems reflect a range of data cable performance, and therefore indicate the suitability of a cable for various applications. Cable performance is ultimately a function of the structure and materials employed in the construction of the cable. To this end, there are numerous methods of cable manufacture well known in the art. By applying these methods alone or in combination, it is possible to produce cables of various attributes and varying data transmission bandwidths.

There are various cable manufacturing methods, some of which, provided by way of example only and merely represents one possible schema for producing cables of various attributes including different bandwidths, are:
1) Base: 7 bare copper strand cores (wires) adding up to 30 AWG with PVC insulation
2) First step up, better insulation, solid polyethylene; larger gauge (less loss) 28 AWG
3) Next step up, gas injected polyethylene insulation (still lower loss, lower dielectric constant)
4) Next step up, silver-plated strand cores for lower surface resistance
5) Next step up, special eye-opener conductors that work as inline passive equalizers plus a Teflon insulation process.

By utilizing such methods, materials, and manufacturing techniques, varying performance can be achieved. For example, a 4 meter cable capable of supporting 2.23 Gbps may require construction according to method 1 listed above, including 7 bare copper strand cores adding up to 30 AWG with PVC insulation. Whereas a 4 meter cable capable of 4.95 Gbps may require construction according to method 2 listed above, including solid polyethylene insulation and larger gauge strand cores adding up to 28 AWG. A 4 meter cable capable of 6.68 Gbps may require construction according to method 3 listed above, including gas injected polyethylene insulation. Whereas, a 4 meter cable capable of 10.20 Gbps may require construction according to method 4 listed above, including silver-plated copper strands. A 4 meter cable capable of 14.93 Gbps may require construction according to method 5, listed above, including use of special conductors and a Teflon insulation process. Actual materials and construction of the cables described herein forms no part of the present invention.

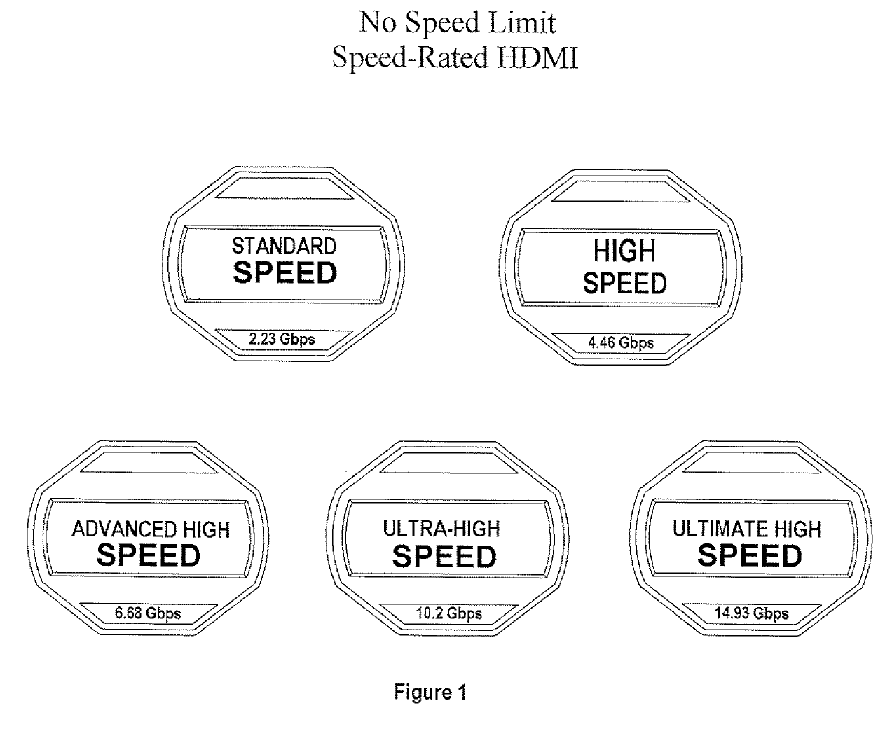

With reference to FIG. 1, an embodiment of the present invention is shown. A series of emblems, serving as the indicia, is depicted to indicate the relative bandwidths of different cable types. As illustrated in FIG. 1, and in accordance with an embodiment of the present invention, these emblems may include speed-rating language which includes the following: standard speed, high speed, advanced high speed, ultra-high speed, and ultimate high speed. In a further embodiment of the present invention, also shown in FIG. 1, standard speed corresponds to a bandwidth of 2.23 Gbps, high speed to 4.95 Gbps, advanced high speed to 6.68 Gbps, ultra-high speed to 10.2 Gbps, and ultimate high speed to 14.93 Gbps. In a further embodiment of the present invention, also shown in FIG. 1, the emblems may comprise substantially octagonal shapes. In alternative embodiments (not shown), the emblems may have any shape, including, without limitation, triangular, rectangular, polygonal (e.g. pentagonal, hexagonal), rounded, etc. In a further embodiment of the present invention, the foregoing speed-rating emblems correspond to different cable types constructed in accordance with the methods listed above.

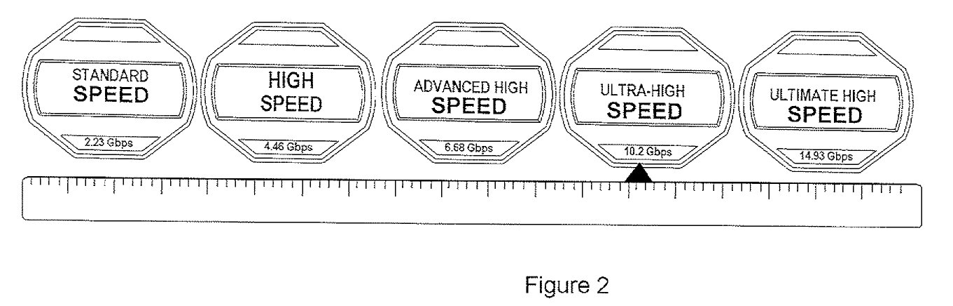

With reference to FIG. 2, an additional embodiment of the present invention is shown. A cohort of speed-rating emblems is illustrated with an underlying scale and adjustable pointer. This illustrates a range of speed-ratings simultaneously and demonstrates their relationship to each other in terms of relative bandwidth capability.

The application of ratings to cables simplifies the presentation of information pertinent to the consumer who is considering purchasing a cable. Instead of multiple measures of data requirements such as resolution, refresh rate, and color depth, a single rating system indicative of overall data transmission requirements and cable capacity can be employed. A salesperson or consumer can refer to such a system and easily discern why it is necessary to have certain types of cable for certain types of equipment.

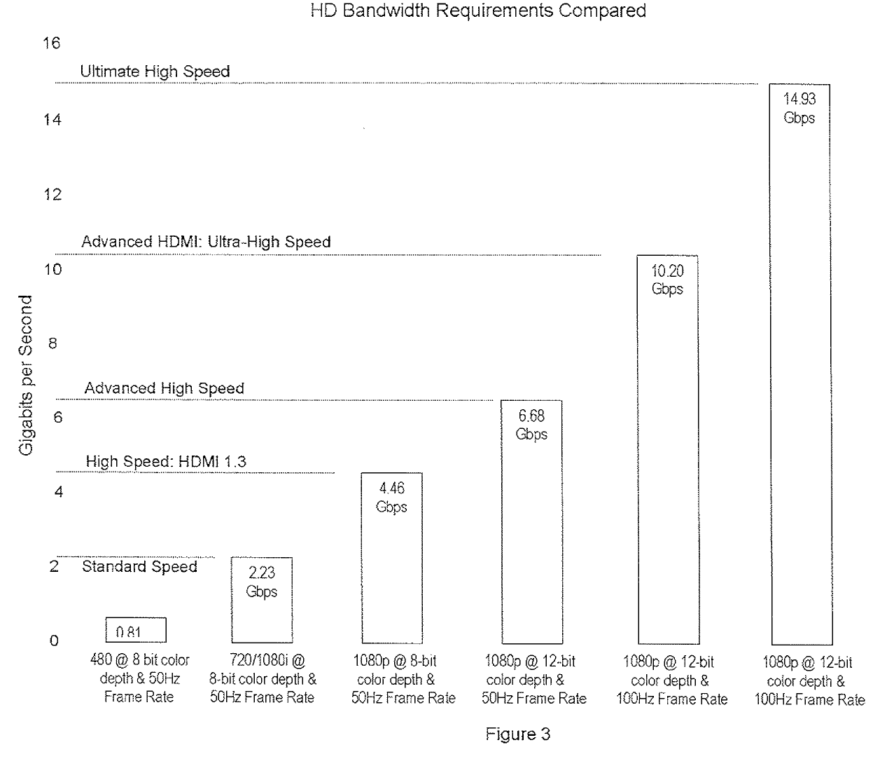

With reference to FIG. 3, a bar chair demonstrating the bandwidth requirements of various video technologies is shown. Corresponding speed-rating language as discussed above is also indicated.

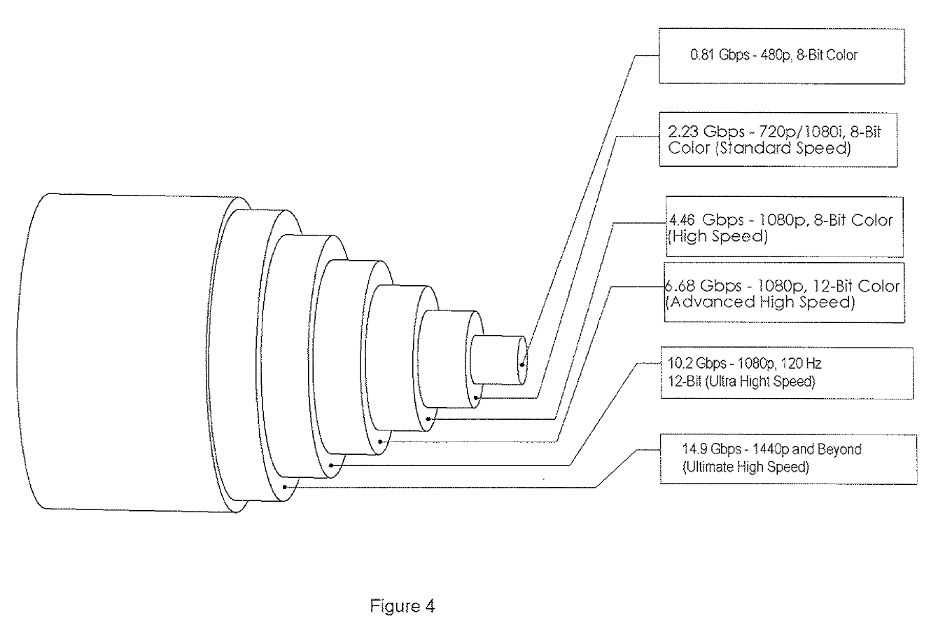

With reference to FIG. 4, a three-dimensional illustration of relative bandwidths of different video formats in accordance with the present invention is shown. Relative bandwidth is shown as a series of concentric cylinders, with narrower cylinders representing lower bandwidth and wider pipes representing larger bandwidth. Relative cross-sectional area correlates with relative bandwidth, but is not necessarily directly proportional. Naturally, relative volume may be correlated with relative bandwidth, as well. As shown, the speed-rating language discussed above may also be applied to the illustration, as these correspond to the bandwidth requirements of the various video technologies. The use of concentric cylinders to illustrate relative bandwidth provides a striking visual presentation that is intuitive and easy to understand. In alternative embodiments (not shown), cylinders may be displayed separately rather than concentrically, and have alternative cross-sectional shapes, such as square, rectangular, or oval.

Moreover, in another embodiment (not shown), a system may be established, or a method may be utilized, to illustrate and represent the attributes of cables. A multitude of cables, from two to millions, and their respective attributes may be stored in a data storage device. The above-mentioned simplified representation may then be applied to each of the stored cables. A consumer or salesperson, or otherwise user, may then provide a user interface with criterion indicating their particular need and requisites of cable attributes, such as price, display resolution, frame rate, and color depth, among others. The system may then generate the inventive representations and indicia, for example generating something similar to FIG. 4, to analyze the user's particular needs with the system's stored cables and the cables' attributes to help determine the more appropriate cable. The displayed cables may be the entire set of stored cables or a subset based upon the user's criterion. The set may be filtered programmatically. By filtering programmatically, cables not corresponding to the entered criterion would not be displayed. To programmatically limit or otherwise determine the cables displayed any of the commonly known means in the art may be utilized.

For example, the PHP and HTML programming languages may be utilized to accept criterion, display data or otherwise interact with a user. The data may be stored in the MySQL database system, as an example.

The foregoing embodiments are provided by way of example only, and are not intended to be limiting in any way. Indeed, upon further study of the present disclosure by those skilled in the art, additional embodiments will become apparent, and these are anticipated within the scope of the present invention.

Information as herein shown and described in detail is fully capable of attaining the above-described object of the invention, the presently preferred embodiments of the invention, and is, thus, representative of the subject matter which is broadly contemplated by the present invention. The scope of the present invention fully encompasses other embodiments which may become obvious to those skilled in the art, and is to be limited, accordingly, by nothing other than the appended claims, wherein reference to an element in the singular is not intended to mean “one and only one” unless explicitly so stated, but rather “one or more.” All structural, electrical, and functional equivalents to the elements of the above-described preferred embodiment and additional embodiments that are known to those of ordinary skill in the art are expressly incorporated herein by reference and are intended to be encompassed by the present claims.

Moreover, it is not necessary for a device or method to address each and every problem sought to be solved by the present invention for it to be encompassed by the present claims. Furthermore, no element, component or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A method for selling cables of varying attributes comprising:
selecting a plurality of cables;
assigning indicia to each of said cables indicative of its performance characteristics;
presenting said indicia in graphical form for comparison.

2. The method of claim 1, wherein said indicia include signal transmission speed ratings.

3. The method of claim 1, wherein said indicia include data transmission speed ratings.

4. The method of claim 1, wherein said indicia are graphically depicted as an emblem.

5. The method of claim 1 wherein said indicia includes:
a series of concentric cylinders;
said cylinders having cross-sectional areas associated with performance characteristics of said cable.

6. The method of claim 1 wherein said cables are high definition multimedia interface cables.

7. The method of claim 1 further comprising;
storing said assigned indicia in memory;
coupling said memory to a user interface having user inputs;
accepting criterion via said user inputs;
selecting said assigned indicia based upon said criterion;
presenting said selected indicia in graphical form.

8. The method of claim 7 wherein said indicia further includes:
a series of concentric cylinders;
said cylinders having cross-sectional areas associated with data transmission capacities of said cables.

9. The method of claim 1 wherein said indicia indicates standard speed, high speed, advanced high speed, ultra-high speed, or ultimate high speed.

10. The method of claim 1 wherein said cables are selected from the group consisting of:
a first cable with seven bare copper strand cores with PVC insulation;
a second cable with improved insulation, solid polyethylene, increased gauge;
a third cable with gas injected polyethylene insulation;
a forth cable type with silver-plated strand cores; or
a fifth cable type with eye-opener conductors that function as inline passive equalizers with a Teflon insulation.

11. The method of claim 1 wherein indicia indicates a standard speed of approximately a bandwidth of 2.23 Gbps, a high speed of approximately a bandwidth of 4.95 Gbps, a advanced high speed of approximately a bandwidth of 6.68 Gbps, a ultra-high speed of approximately a bandwidth of 10.2 Gbps, and a ultimate high speed of approximately a bandwidth of 14.93 Gbps.

12. A method for demonstrating cable attributes comprising:
storing a plurality of cables and their respective performance characteristics in memory;
assigning indicia to said cables according to their said respective performance characteristics;
coupling a user interface to user inputs;
accepting criterion via said user inputs;
displaying said indicia related to said criterion.

13. The method of claim 12 wherein said indicia further includes:
a series of concentric cylinders;
said cylinders having cross-sectional areas associated with data transmission capacities of said cable.

14. The method of claim 12, wherein said indicia are graphically depicted as an emblem.

15. The method of claim 12, wherein said indicia are displayed simultaneously and demonstrates their relationship to each other in terms of relative bandwidth capability.

16. The method of claim 12 wherein said criterion includes one or more of video resolution, frame rate, price or color depth.

17. The method of claim 12 wherein said indicia demonstrates signal transmission characteristics.

18. The method of claim 12 wherein indicia indicates a standard speed of approximately a bandwidth of 2.23 Gbps, a high speed of approximately a bandwidth of 4.95 Gbps, a advanced high speed of approximately a bandwidth of 6.68 Gbps, a ultra-high speed of approximately a bandwidth of 10.2 Gbps, and a ultimate high speed of approximately a bandwidth of 14.93 Gbps.

19. The method of claim 12 wherein said cables are selected from the group comprising:
a first cable with seven bare copper strand cores with PVC insulation;
a second cable with improved insulation, solid polyethylene, increased gauge;
a third cable with gas injected polyethylene insulation;
a forth cable type with silver-plated strand cores; or
a fifth cable type with eye-opener conductors that function as inline passive equalizers with a Teflon insulation.

20. An apparatus for demonstrating cables of various attributes comprising:
a data storage device;
said data storage device for storing data of indicia and performance characteristics of a plurality of cables, said indicia according to said performance characteristics;
a user interface coupled to said data storage device, for imputing criterion;
a display device for displaying said data, said data related to said user inputs.
